(19) United States
(12) Patent Application Publication
(10) Pub. No.: US 2011/0318022 A1
(43) Pub. Date: Dec. 29, 2011

(54) IMAGE FORMING APPARATUS AND IMAGE FORMING METHOD

(75) Inventor: Hisanobu Ajima, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/166,950

(22) Filed: Jun. 23, 2011

Related U.S. Application Data
(60) Provisional application No. 61/359,448, filed on Jun. 29, 2010.

(51) Int. Cl. G03G 15/00; G03G 15/08

(52) U.S. Cl. 399/12; 399/27; 399/43; 399/44

(57) ABSTRACT

An image forming apparatus includes an image forming unit including a developing device, a toner cartridge to store toner supplied to the developing device, a first memory which is provided in the toner cartridge and in which characteristic data of the toner is written, a detection mechanism to detect a parameter to influence toner cohesion, a second memory to store the detected parameter, and an arithmetic control mechanism to determine a use limit of the toner cartridge based on the characteristic data and the parameter.

### CROSS-REFERENCE TO RELATED APPLICATION

This application is based upon and claims the benefit of priority from the prior U.S. Provisional Patent Application No. 61/359,448 filed on Jun. 29, 2010, the entire contents of which are incorporated herein by reference.

### FIELD

Embodiments described herein relate generally to an image forming apparatus and an image forming method.

### BACKGROUND

In an image forming apparatus, in general, in order to prevent defects such as toner cohesion due to heat from occurring, the temperature in a machine is controlled. However, the control of the temperature in the machine becomes difficult with the miniaturization of the apparatus.

On the other hand, in recent years, fixing temperature is lowered by using a low melting point toner, and the power saving of the image forming apparatus is realized. In the low melting point toner, although a melting point is low, the storage property under a high temperature environment deteriorates. Thus, the image defect due to the cohesion occurs.

Then, it is conceivable to suppress the cohesion by providing a cooling apparatus for lowering the temperature in the machine or by increasing the additive coating ratio of a toner particle. However, there occurs a problem that the cost increases.

### BRIEF DESCRIPTION OF THE DRAWINGS

FIG. 1 is a structural view of an image forming apparatus which is a four-tandem color printer of an embodiment;

FIG. 2 is a schematic structural view of an image forming unit of the embodiment;

FIG. 3 is a block diagram of components in which control of the image forming unit is performed of the embodiment;

FIG. 4 is a correspondence table of address and information content in a memory of the image forming unit of the embodiment;

FIG. 5 is a correspondence table of address and information content in a memory of a toner cartridge of the embodiment; and

FIG. 6 is a flowchart of an operation of the embodiment.

### DETAILED DESCRIPTION

Reference will now be made in detail to the present embodiment of the invention, an example of which is illustrated in the accompanying drawing.

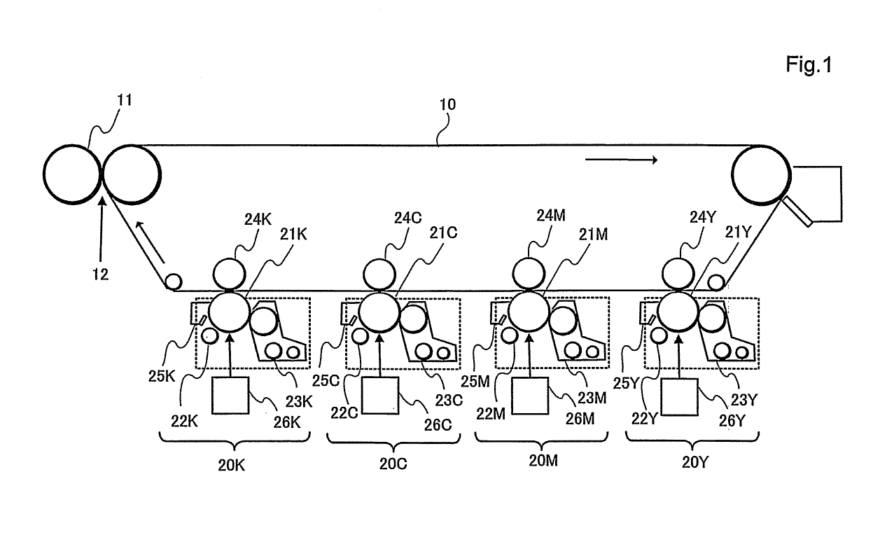

FIG. 1 is a structural view of an image forming apparatus which is a four-tandem color printer and is an example of an image forming apparatus (MFP) of an embodiment. As shown in FIG. 1, a secondary transfer roller 11 to transfer an image on an intermediate transfer belt 10 onto a transfer medium 12, and image forming units 20Y, 20M, 20C and 20K of yellow, magenta, cyan and black are arranged along a conveyance direction (arrow direction) of the intermediate transfer belt 10.

The image forming units 20Y, 20M, 20C and 20K include photoreceptors 21Y, 21M, 21C and 21K as image carriers. Further, chargers 22Y, 22M, 22C and 22K as charging units, developing devices 23Y, 23M, 23C and 23K including developing rollers as developing members and containing developers including respective color toner particles of yellow, magenta, cyan and black and carrier particles, primary transfer rollers 24Y, 24M, 24C and 24K as transfer units, and cleaner units 25Y, 25M, 25C and 25K are provided around the respective photoreceptors. These are respectively arranged along rotation directions of the corresponding photoreceptors 21Y, 21M, 21C and 21K.

The respective primary transfer rollers 24Y, 24M, 24C and 24K are disposed inside the intermediate transfer belt 10, and nip the intermediate transfer belt 10 in cooperation with the corresponding photoreceptors 21Y, 21M, 21C and 21K. Exposure devices 26Y, 26M, 26C and 26K are respectively arranged so that exposure points are formed on outer peripheral surfaces of the photoreceptors 21Y, 21M, 21C and 21K between the chargers 22Y, 22M, 22C and 22K and the developing devices 23Y, 23M, 23C and 23K. The secondary transfer roller 11 is arranged outside the intermediate transfer belt 10 so as to contact therewith.

A print operation is performed as described below by the image forming apparatus constructed as described above. A toner image of yellow formed on the photoreceptor of the image forming unit 20Y is primarily transferred onto the intermediate transfer belt 10. The toner image is formed in the image forming unit 20Y. The same process is performed also in the image forming units 20M, 20C and 20K in synchronization with a timing of the toner image formation in the image forming unit 20Y. The toner images of magenta, cyan and black formed on the photoreceptors of the image forming units 20M, 20C and 20K are also sequentially primarily transferred onto the intermediate transfer belt 10.

The transfer medium 12 is conveyed from a cassette (not shown), and is sent to the intermediate transfer belt 10 by an aligning roller (not shown) in synchronization with the timing of the toner image on the intermediate transfer belt 10.

A bias (+) having a polarity opposite to a toner charge polarity is applied to the secondary transfer roller 11 by a power source (not shown). As a result, the toner image on the intermediate transfer belt 10 is transferred onto the transfer medium 12 by a secondary transfer voltage applied between the intermediate transfer belt 10 and the secondary transfer roller 11. A fixing unit (not shown) to fix the toner transferred on the transfer medium 12 is disposed, and a fixed image is obtained by causing the transfer medium 12 to pass through the fixing unit (not shown).

Incidentally, here, although the description is made on the example in which the image forming units are arranged in the order of yellow, magenta, cyan and black, the color order is not particularly limited.

Hereinafter, the details of the image forming apparatus of the embodiment will be described.

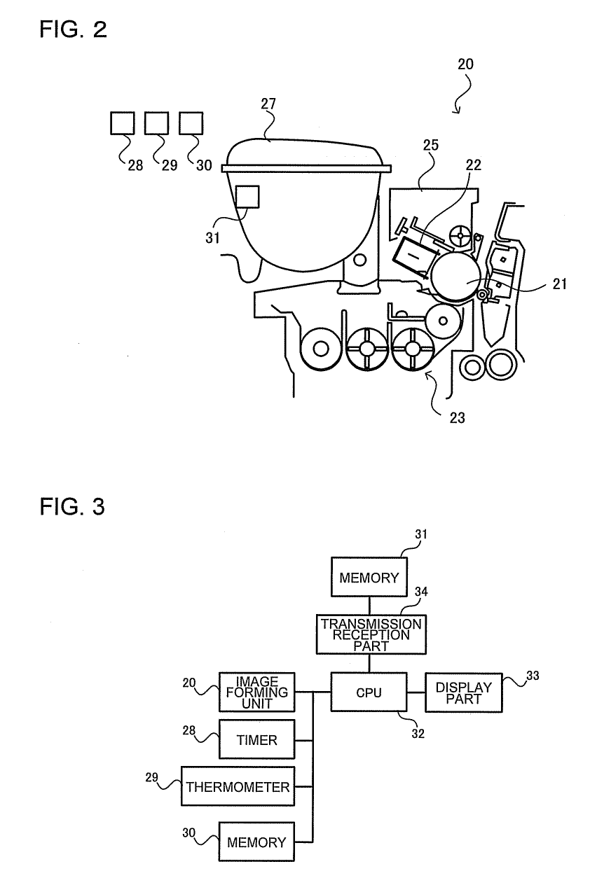

FIG. 2 is a schematic structural view of an image forming unit 20 of the image forming apparatus which is constructed as described above and in which an image is formed. Incidentally, the image forming units 20Y, 20M, 20C and 20K have the same structure.

As shown in FIG. 2, a charger 22, a developing device and a cleaning unit 25 are arranged around a photoreceptor 21. A toner cartridge 27 is mounted to the developing device 23. Further, a timer 28 to detect a time when the toner cartridge 27 is attached, and a thermometer 29 to detect a temperature in a machine are provided.

The image forming unit includes a memory 30 in which toner information and control information are stored, and the toner cartridge 27 includes a memory 31 in which toner characteristic information is stored.

In the image forming unit 20 as described above, a print operation is performed as described below, and a use limit of the toner cartridge 27 is obtained. FIG. 3 is a block diagram of components in which control is performed. As shown in FIG. 3, a CPU 32 as an arithmetic control mechanism for controlling the image forming unit 20 is connected to the timer 28 and the thermometer 29 which are detection mechanisms to detect parameters to influence toner cohesion, and a display part 33 to display instructions to a user.

The CPU 32 is connected to the memory 30 of the image forming unit 20 and is connected to the memory 31 of the toner cartridge 27 through a transmission and reception part 34.

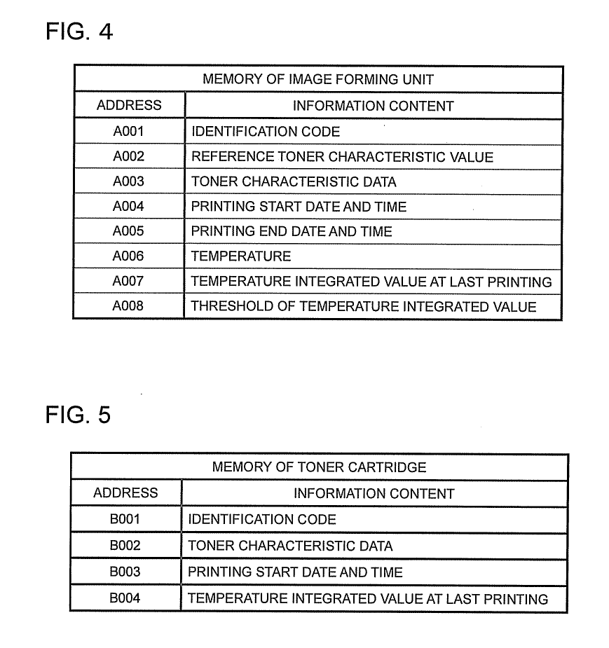

FIG. 4 is a correspondence table of address and information content in the memory 30 of the image forming unit, and FIG. 5 is a correspondence table of address and information content in the memory 31 of the toner cartridge.

As shown in the table of FIG. 4, the memory 30 includes, for respective addresses, an area (A001) in which an identification code is stored, an area (A002) in which a reference toner characteristic value (for example, Tg (glass transition point)=55° C.) is stored, and an area (A003) in which toner characteristic data such as Tg read from the memory 31, described later, is written.

Further, in order to detect a print time and a temperature which are the parameters to influence the toner cohesion, the memory 30 includes an area (A004) in which a printing start date and time is written, an area (A005) in which a printing end date and time is written, and an area (A006) in which the temperature is written, and further includes an area (A007) in which a temperature integrated value at the last printing described later is written, which is an integrated value for determining the use limit, and an area (A008) in which a threshold (for example, 5500) of the temperature integrated value is stored.

As shown in the table of FIG. 5, the memory 31 includes, for respective addresses, an area (B001) in which an identification code is inputted, and an area (B002) in which toner characteristic data such as Tg (glass transition point) of toner stored in the toner cartridge 27 is written. The toner characteristic data may be any characteristic that influences the toner cohesion, and may be another temperature characteristic, storage property or the like.

The storage property is evaluated by, for example, an easiness of toner cohesion obtained by a following measurement method.

### <Storage Property Measurement Method>

(1) After toner of 20 g is put in a polyethylene bottle of 100 cc, the bottle is covered with a lid, and is heated for 8 hours in a water tank of 50° C.

(2) The toner is extracted from the water tank and is left for 8 hours at a room temperature.

(3) The toner after heating is put on a sieve of 42 mesh, and is sieved while a vibration is applied by a powder tester made by HOSOKAWA MICRON CORPORATION.

(4) An amount of toner on the sieve is measured.

As the measured amount of toner becomes large, the cohesion easily occurs.

Further, the memory 31 includes an area (B003) in which the date and time written in A004 is written, and an area (B004) in which the temperature integrated value at the last printing is written.

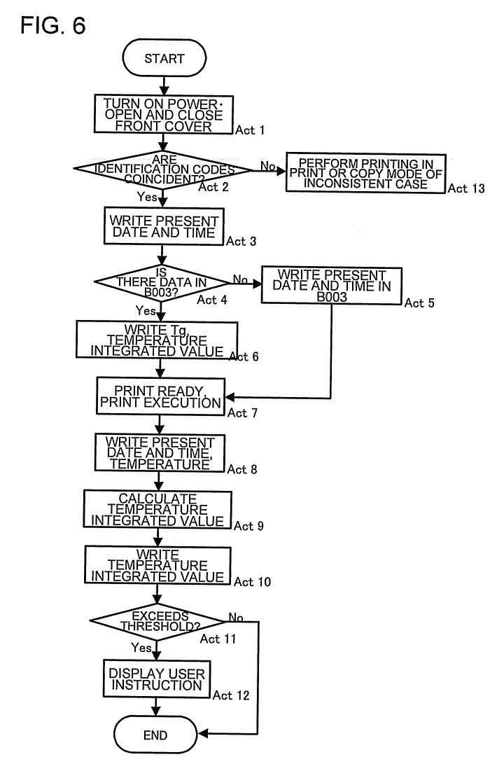

FIG. 6 is a flowchart. As shown in FIG. 6, a power source is turned ON or a front cover is opened, and a new toner cartridge is attached (Act 1).

The identification code is stored in A001 of the memory 30, the reference toner characteristic value is stored in A002, and the threshold of the temperature integrated value is stored in A008. It is determined whether the identification code inputted in A001 is coincident with the identification code inputted in 3001 of the memory 31 (Act 2). When not coincident, the toner cartridge is replaced, or printing is executed in a print or copy mode of an inconsistent case (Act 13).

When the identification codes are coincident with each other, the present date and time detected by the timer 28 is written in A004 (Act 3), and the presence or absence of writing of data in 3003 is determined (Act 4). When writing is not performed, the date and time of A004 is written in B003 (Act 5). Incidentally, when the data is written in 3003, the temperature integrated value at the last printing, described later, is written in 3004.

The toner characteristic data Tg of 3002 and the temperature integrated value of B004 are read, and are written in A003 and A007 (Act 6) respectively. A print ready state occurs, and printing is performed (Act 7).

The present date and time detected by the timer 28 at the time of completion of the printing is written in A005, the temperature detected by the thermometer 29 at the time of completion of the printing or during the printing is written in A006 (Act 8), and a temperature integrated value (D) is obtained by a following expression (Act 9).

temperature integrated value (D)=toner load coefficient (A)×temperature in machine (B)×print time (C)

toner load coefficient (A)=reference toner characteristic value (A002)/toner characteristic data (A003)

temperature in machine (B): temperature exceeding 50° C.=temperature in machine (A006)−50

print time (C)=printing completion date and time (A005)−printing start date and time (A004)

The obtained temperature integrated value (D) is written in A007. When the temperature integrated value at the last printing is written in A007, the temperature integrated value at the last printing is added, and the obtained value is newly written in A007 (Act 10). The temperature integrated value written in A007 is newly written in B004.

It is determined whether the temperature integrated value (D) written in A007 exceeds the threshold of A008, for example, 5500 (Act 11). When exceeds the threshold, it is determined that the toner cartridge reaches the use limit. The display part 33 displays instructions to the user, for example, replacing the toner cartridge, removing and shaking the toner cartridge (manually agitating the toner), or stopping a two-sided mode in which the temperature more rises (Act 12). Further, when the image forming apparatus is connected to a network, a service department may be informed that the cartridge reaches the use limit.

Incidentally, when the temperature integrated value reaches the threshold or a specified value less than that, a process condition such as a charge voltage, a developing bias and a laser output power, an agitation condition in the toner cartridge 27 or the like may be changed.

The print operation is performed as described above, the use limit of the toner cartridge is obtained, and the replacement instruction of the toner cartridge or the like is performed to the user, so that the image defect due to the toner cohesion can be prevented.

While certain embodiments have been described, these embodiments have been presented by way of example only, and are not intended to limit the scope of the inventions. Indeed, the novel embodiments described herein may be embodied in a variety of other forms; furthermore, various omission, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit including a developing device;
a toner cartridge configured to store toner supplied to the developing device;
a first memory which is provided in the toner cartridge and in which characteristic data of the toner is written;
a detection mechanism configured to detect a parameter to influence toner cohesion;
a second memory configured to store the detected parameter; and
an arithmetic control mechanism configured to determine a use limit of the toner cartridge based on the characteristic data and the parameter.

2. The apparatus of claim 1, wherein the use limit is determined based on whether an integrated value calculated from the characteristic data and the parameter exceeds a threshold.

3. The apparatus of claim 1, wherein the parameter is a print time and a temperature.

4. The apparatus of claim 3, wherein the temperature is a temperature exceeding a specified temperature at time of printing or completion of the printing.

5. The apparatus of claim 3, wherein the use limit is determined based on a temperature integrated value calculated from the characteristic data, the print time and the temperature.

6. The apparatus of claim 1, wherein the characteristic data is a toner temperature characteristic or a storage property.

7. The apparatus of claim 2, wherein the integrated value is written in the second memory.

8. The apparatus of claim 2, wherein the threshold is previously stored in the second memory.

9. The apparatus of claim 2, wherein the integrated value is written in the first memory.

10. The apparatus of claim 1, further comprising a display part to display an instruction to a user when it is determined that the toner cartridge reaches the use limit.

11. An image forming method, comprising:
attaching a toner cartridge storing toner to an image forming unit;
performing printing;
detecting a parameter to influence cohesion of the toner; and
determining a use limit of the toner cartridge based on the parameter and previously stored characteristic data of the toner.

12. The method of claim 11, wherein the use limit is determined based on whether an integrated value calculated from the characteristic data and the parameter exceeds a threshold.

13. The method of claim 11, wherein the parameter is a print time and a temperature.

14. The method of claim 13, wherein the temperature is a temperature exceeding a specified temperature at time of printing.

15. The method of claim 13, wherein the use limit is determined based on a temperature integrated value calculated from the characteristic data, the print time and the temperature.

16. The method of claim 11, wherein the characteristic data is a toner temperature characteristic or a storage property.

17. The method of claim 11, wherein an integrated value is written in a first memory attached to the toner cartridge.

18. The method of claim 11, wherein an integrated value is written in a second memory attached to an image forming apparatus.

19. The method of claim 12, wherein the threshold is stored in a second memory attached to an image forming apparatus.

20. The method of claim 11, wherein when it is determined that the toner cartridge reaches the use limit, an instruction to a user is displayed.
